(19) United States
(12) Patent Application Publication
(10) Pub. No.: US 2017/0366579 A1
(43) Pub. Date: Dec. 21, 2017

(54) SYSTEM AND METHOD FOR CONTROLLED CUSTOMIZATION OF BRANDED ARTWORK

(71) Applicants: Mariana Assuncao Aguiar, Mermaid Beach (AU); Alexander David William Rich, Upper Coomera (AU)

(72) Inventors: Mariana Assuncao Aguiar, Mermaid Beach (AU); Alexander David William Rich, Upper Coomera (AU)

(21) Appl. No.: 15/183,805

(22) Filed: Jun. 16, 2016

(51) Int. Cl. H04L 29/06; G06T 11/60; G06F 3/0484

(52) U.S. Cl. CPC H04L 63/20; H04L 63/102; G06F 3/04845; G06T 11/60; G06T 2200/24

(57) ABSTRACT

Disclosed is a system and method for online editing to create artwork with layers. The present disclosure describes about the method of managing and using branded materials. According to an embodiment, the method of managing the branded materials includes creating an account for a user by a business admin, providing business role to the user, managing the users, creating templates with restrictions to selected areas by the users based on the users role, managing the templates by a business representative, analyzing a data related to a artwork created using said templates and/or campaigns, and managing activity permissions assigned to the users. According to another embodiment, the method of using the branded materials includes creating a new artwork by selecting at least one template from multiple templates, and editing the selected template according to one or more restrictions associated with the templates.

### FIELD OF INVENTION

The present application generally relates to a controlled customization of branded artwork by assigning different usage rights to users depending upon their roles.

### BACKGROUND

Different online design tools allow for collaboration between team members, and template creation, which helps different stakeholders to collaborate and access design assets. However, they lack the control on how the templates and the assets are used by different users on various levels. Even though there are some other design tools known in the art, no such software tool offers a way for an organization to control the way, people interact with the content they are making available.

One such editor tool is Canva that offers a solution which allows businesses to collaborate in their designs and create templates that can be used by multiple users within an organization. However, this tool does not allow businesses to control how the templates are used.

Again, alternative methods such as outsourcing to a third party design agency can be a seemingly easy solution but can be expensive for businesses when minor changes need to be made in the designs. It also takes time out of the campaign's launch and overall success.

A number of prior arts are in the public domain dealing with the online editing of the content like artworks. For example, Pat. No. EP1560139A1 issued to Jaffe Associates LLC discloses a system for efficiently and effectively producing target-based content, while maintaining the security of proprietary content through a hierarchical access scheme. The associated method produces target-based content for presentation in a cost effective manner as it conserves resources involving advanced printing of multiple content versions. The method also advantageously enable for the assembly of preformatted content documents, as well as the preservation or alteration of the original document formatting.

Similarly, U.S. Pat. Appl. No. US20140257935A1 issued to Mediaspectrum, Inc. discloses a computer implemented method for advertisement management. It can provide major strategic advantages to companies, such as, online and directory publishers who want to take advantage of the new mobile devices, and/or provide for more effective and efficient advertising, content management, and publishing capabilities.

Similarly, U.S. Pat. No. 7,703,021B1 issued to Sparta Systems, Inc. discloses techniques for controlling access to components of a highly-configurable system for controlling processes. The inventions provide new user permissions for records in a process control system. The process control system permits the user to view a process-related record to which the user is related only to the extent specified by the permission value. In the database system, a particular process-related record each user is associated with a permission value that indicates an extent to which the user may view a process-related record to which the user is related.

Similarly, U.S. Pat. No. U.S. Pat. No. 8,887,047B2 issued to Breakthrough Performancetech, LLC discloses a method for training program generation. It provides a view control and edits controls with some or all of the fields being user editable. The view control and/edit control are provided in association with a respective style, which if activated, causes a user interface, such as the example user interface.

Thus, in the light of the above mentioned prior arts and existing problems, it is evident that, there is a need for a method and system that have the ability to restrict how each element of an artwork is used, considering each user roles.

### SUMMARY

It is an objective of the present invention to provide a system and method. This invention will allow anyone involved with an organization, from staff members, to outsourced workforce, to consumers, to create their own versions of branded artwork without modifying it in any way that was not intended by the organization, or compromising the brand's visual identity. More specifically the present invention allows organizations to control what parts of branded artwork can be edited by others, and what exact changes can be made. The organizations will also be able to control what functionality is available to other users, and choose if they would like to approve the customized and/or new version of the artwork before it is printed, shared, published, or downloaded by the user.

One another objective of the invention describes about the branded artwork that can be used by anyone with assurance that stakeholders will only customize what they are allowed to.

It is yet another object of the present invention to enable the users of the branded artworks to edit them even if they have no technical skills. The users can directly share them on social media, or even print them locally in minutes without having to involve anyone in the head office, and be able to do it from their computer, tablet, or phone.

It is yet another object of the present invention to provide with the analytics, which will allow the organization to see how the users are using the artwork, and what the reach of their campaigns are through social media. Firstly, brand managers need internal and external stakeholders to customize branded marketing materials so that they can fulfil their own marketing needs. From being able to post content on social media, to tweaking ads for a local market, to making adjustments to a flyer before it goes to print. The organizations currently spend a lot of their marketing budget getting professional designers, who could be focusing instead in creativity and innovation, to make minor changes, or to create new versions of existing designs. It's also common for the stakeholders, especially if they are a local representative of the organization, to have to hire a local design agency themselves to make these changes.

It is yet another object of the present invention to allow the brand managers to effectively control their marketing materials to be used by their B2B and B2C customers in order to increase their campaigns' reach. This invention will allow for user-generated content marketing to be executed in a controllable fashion. The brand will be exposed to their customer's network without having to rely on viral traction or paid advertising, and transform anyone involved with the organization into an ambassador.

It is yet another object of the present invention to save enterprises time and money, by allowing anyone in the business to interact with their branded materials without needing a middle man, whilst giving the business representative the peace of mind that the brand's visual identity will stay intact.

In the known marketing techniques such as franchise marketing, funds are effective as they allow stores to run campaigns that they would not be able to afford on their own. However, the campaigns that the head office chooses to execute might not always meet the needs of the franchisees. The present invention will help franchisees to create their own versions of marketing materials to suit their language, prices, and product-offering requirements.

It is well known fact that small and medium businesses do not have the big marketing budgets and must be very careful with what marketing strategies they invest in for the greatest return on investment. By keeping these parameters in mind it is yet another object of the present invention that will allow their business partners and consumers to generate visual content that promotes their brand, and transforming everyone in a brand ambassador, and increasing their campaigns' reach.

It is yet another object of the present invention to offer an easy-to-use online based solution which eliminates the need for technical skills in design software, such as Illustrator and Photoshop.

It is yet another object of the present invention to facilitate all users with a secure method of editing artwork on their own, as current there is no way to restrict by whom and how the artwork is edited.

It is yet another object of the present invention that facilitates the media that is prepared can be locked so that the visual identity or the whole design is kept exactly as the business' representative wished to see it portrayed. This invention will give the control back to the user to invite team members to customize specific elements of a design without jeopardizing the brand identity.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a schematic block diagram disclosing business account management and roles, according to an embodiment of the present invention.

FIG. 2 is a schematic block diagram disclosing business template creation process, according to an embodiment of the present invention.

FIGS. 3a and 3b discloses a template manager user interface that allows a business representative to manage the created templates.

FIG. 4 is a schematic block diagram disclosing template usability process, according to an embodiment of the present invention.

FIG. 5 discloses the analytics user interface that provides data to users for analysis.

FIG. 6 discloses an activity manager user interface.

FIG. 7a is an exemplary embodiment representing user roles and usage rights.

FIG. 7b discloses an exemplary list of users with their business roles.

FIG. 8 discloses about the library access of the system.

FIG. 9a discloses about various templates.

FIG. 9b discloses another exemplary embodiment about various templates.

FIG. 10 is a tool that discloses about uploading/inserting various images. It also displays text tool that discloses various functionalities for editing text.

FIG. 11a represents a customization tool for inserting and editing various shapes.

FIG. 11b represents a customization tool for inserting and editing various vector art.

FIG. 11c represents a customization tool for inserting and editing various backgrounds.

FIG. 12 discloses an import module for inserting images.

FIG. 13a discloses settings module and various options for jpeg file types.

FIG. 13b discloses settings module and various options for png file types.

FIG. 13c discloses settings module and various options for pdf file types.

FIG. 14 discloses a library and various colors and fonts.

FIG. 15 discloses available colors and fonts in details.

FIG. 16 discloses about the restrictions available according to usage rights.

### DETAILED DESCRIPTION OF THE INVENTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples. The invention can be better understood with the help of detailed description of the drawings and preferred embodiments of the invention.

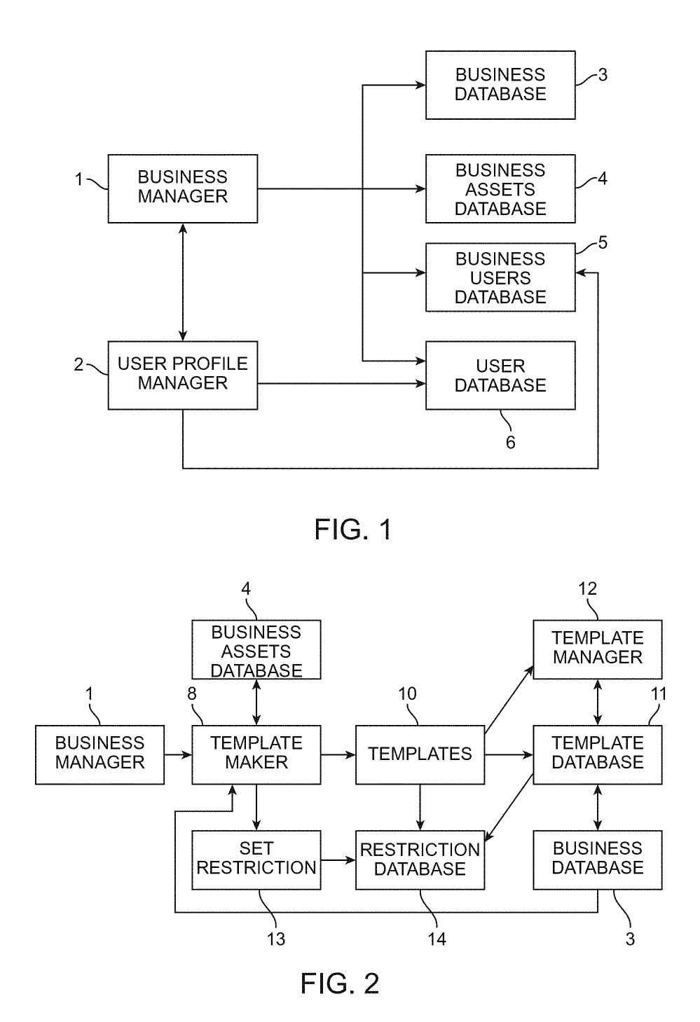

Referring to FIG. 1 discloses a schematic block diagram of a business account management and various roles. A business admin invites and associates a role to a user using the business manager (1). The user can accept or decline the invitation using his user profile manager (2). The user profile manager interface allows the users to manage the information and content associated with his/her profile, which is stored in the user database (6). The business also adds their design assets to the business assets database (4) and account information to the business database (3) through the business manager (1). Once the invitation is accepted by the user, the user connection to the business and his/her role information is registered on the user database (6), and on the business users database (5). Businesses administrators can change the user role, or disconnect a user from the organization at any time using the business manager (1). The users can disconnect themselves from the organization using their user profile manager (2). The user database (6) is used to store each user unique id, the information associated with it, artwork that has been created by the user, and content that the user added to his/her library including logos, images, backgrounds, fonts and colors. The business database (3) stores each business unique id. It also includes the following: the business users database (5) that stores associated users, their roles in the business, and when they login, the business assets database (4) where the business' design assets are stored including logos, images, backgrounds, fonts and colors and the template database (11) where all the templates are stored, as well as when and to whom they are available to, and by whom and when they have been used. The business manager (1) is a user interface that allows a business administrator to manage the business details, the users associated with the business and their roles, and the business design assets. Once a new account has been created for a business, the user who has created the account will have access to the business manager (1). The business manager is accessible from the user profile manager (2), where the user switches from the person view to a business view. The user profile manager (2) is the user interface that allows a user to manage the information associated with his/her profile.

Referring to FIG. 2 discloses a schematic block diagram of a business template creation process. A template (10) is a pre-designed artwork which facilitates the design process for users. The businesses can access the template maker (8) from the business manager (1). The template maker (8) allows authorized business users to create unique artwork templates with layers and set restrictions for other user roles. The business database (3) sends the information on the roles available within the business to the template maker. The businesses can then set restrictions (13) based on the user roles available. The business design assets (4) are accessible from the template maker (8). The templates (10) are created and stored in the template database (11) and the restrictions associated with the user roles are stored in the restriction database (14). New templates are recorded on the template database (11) and new templates are shown up in the template manager (12).

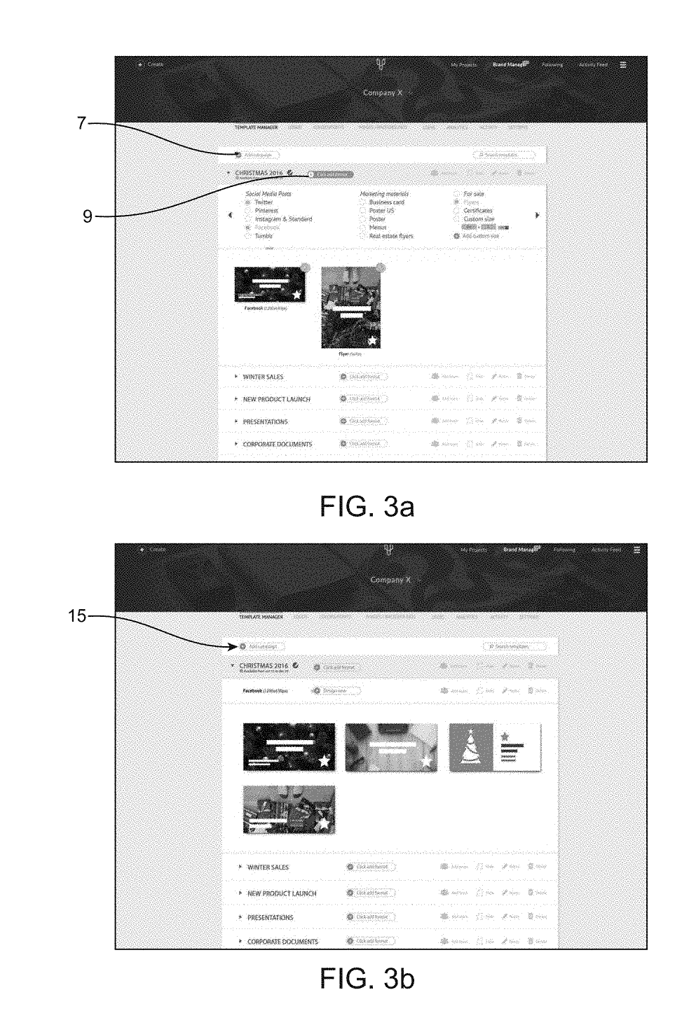

Referring to FIGS. 3a and 3b discloses the template manager (12) user interface that allows an authorized business representative to manage the templates that were created. The templates are grouped into formats, and the formats are grouped into campaigns. Each campaign can be made available to users depending on their roles, and be available during a certain period of time. It is also where users with campaign management permissions can create new campaigns (7), add new formats (9), and create new templates (15). The template database (11) stores the information that the template (10) is associated with the business.

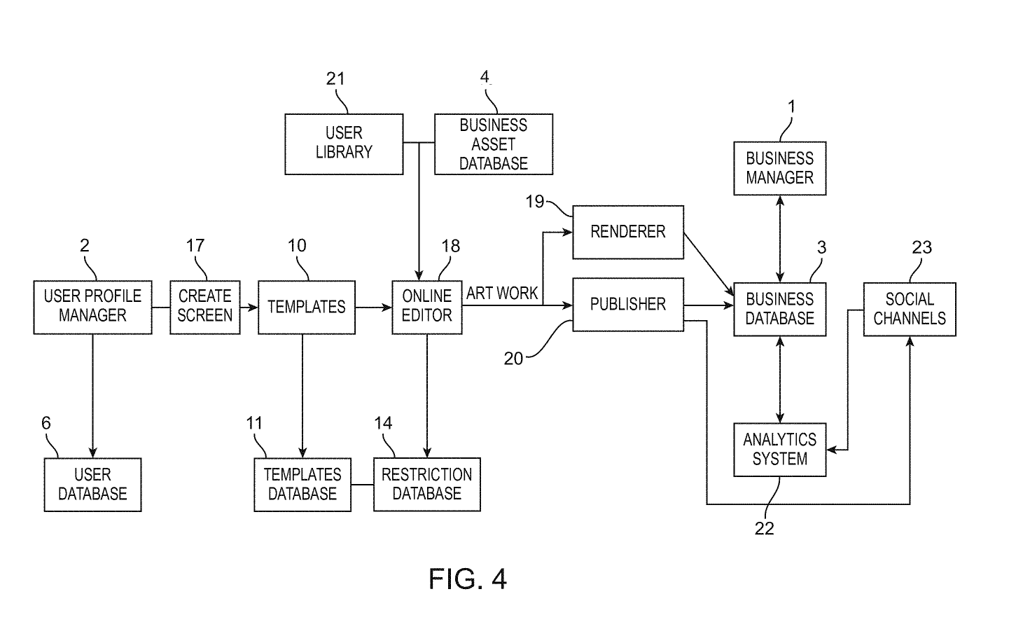

Referring to FIG. 4 discloses a schematic block diagram disclosing the usability process for authorized users utilizing a template to create their own artwork. The user logs in the system and the user database (6) is accessed to authenticate if the user is associated with a business and to identify the role of user. The user uses the user profile manager (2) to access the create screen (17). The create screen (17) will display the campaigns and formats available according to the user's authentication and usage rights. The user chooses a campaign and the format of artwork they would like to create. A selection of templates will appear based on the template database (11). In case the user is authorized to see certain templates, then those templates (10) will be displayed as an option to the user to edit. The online editor (18) allows users to create unique artwork with layers based on a template (10). Once a template (10) is selected, the online editor (18) accesses the restriction database (14) to verify what the user is authorized to edit, and apply these restrictions. The user will be prompted to replace text fields and images, and if the user tries to change what he/she is not allowed to, the system will notify the user and not allow the change. A list of the element restrictions stored in on the restriction database (14) is always available so that the user knows what can be edited. The users can access their personal library content, as well as the business assets if the users have permission for the same. A user library (21)—a part of the user's database that stores the user's content including logos, images, backgrounds, fonts and colors. Once the artwork is created, the users can share and download the file according to their permissions and requirements using publisher module (20) and renderer module (19). The use of the artwork is recorded on the business database (3) and the artwork is recorded on the user database. The information is displayed on business manager (7) to authorized users for approval and reporting purposes. If the artwork is shared on social media using the publisher, the analytics system (22) queries the social media channels APIs (23) to determine the shared artwork's reach.

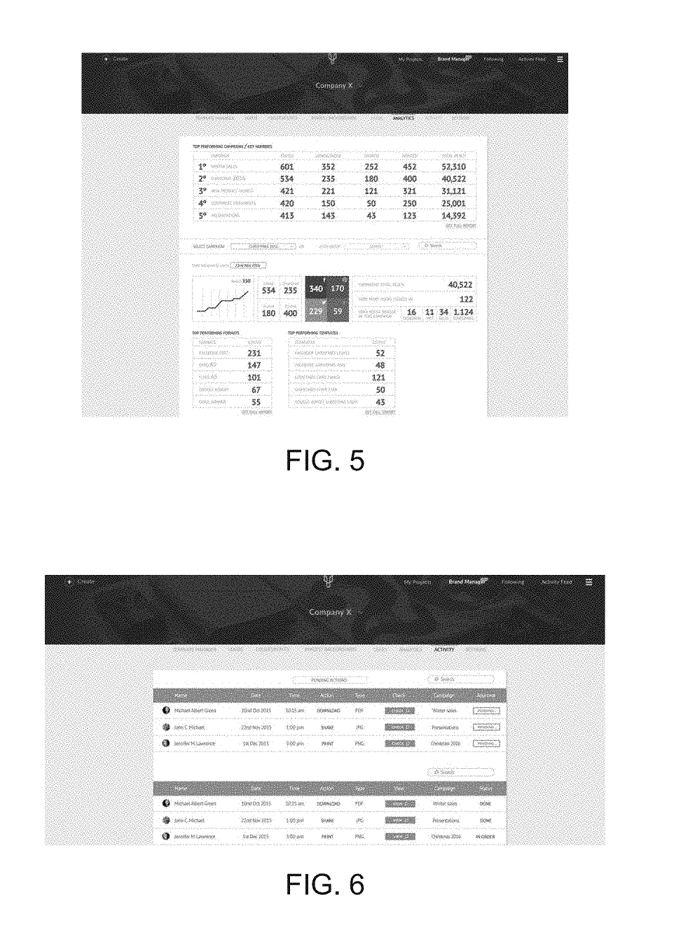

Referring to FIG. 5 discloses the analytics user interface (22) allows the users with analytics permissions to view data related to the templates/campaigns that are made available to users. This data will include, but it's not limited to how many times a template was used to create artwork, how many times the created artworks were downloaded, and shared on social media, the campaigns total reach (considering shares and views on social media), how many users logged in, and the user roles who are interacting with the campaigns the most.

Referring to FIG. 6 discloses an activity manager user interface that allows the users with activity permissions to see their required actions including but not limited to approving or rejecting changes, authorizing artwork to be printed and authorizing artwork to be shared. It also allows them to view other users' activities.

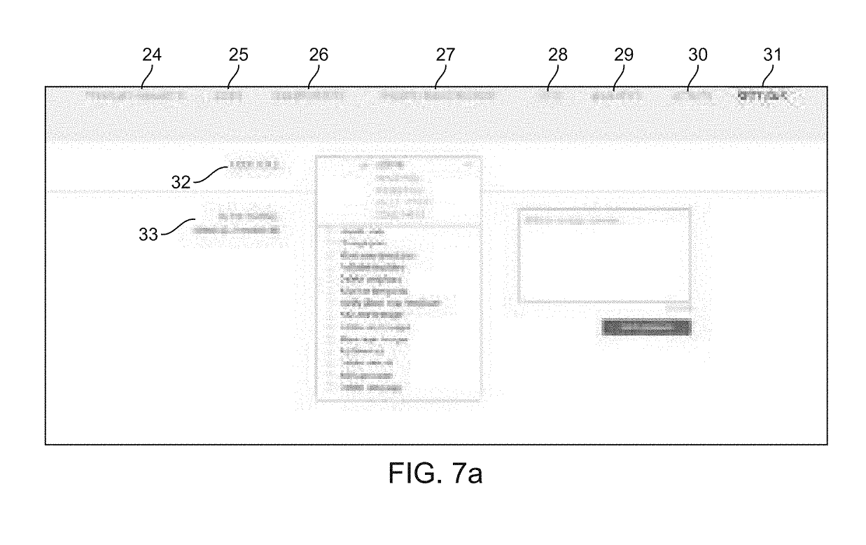

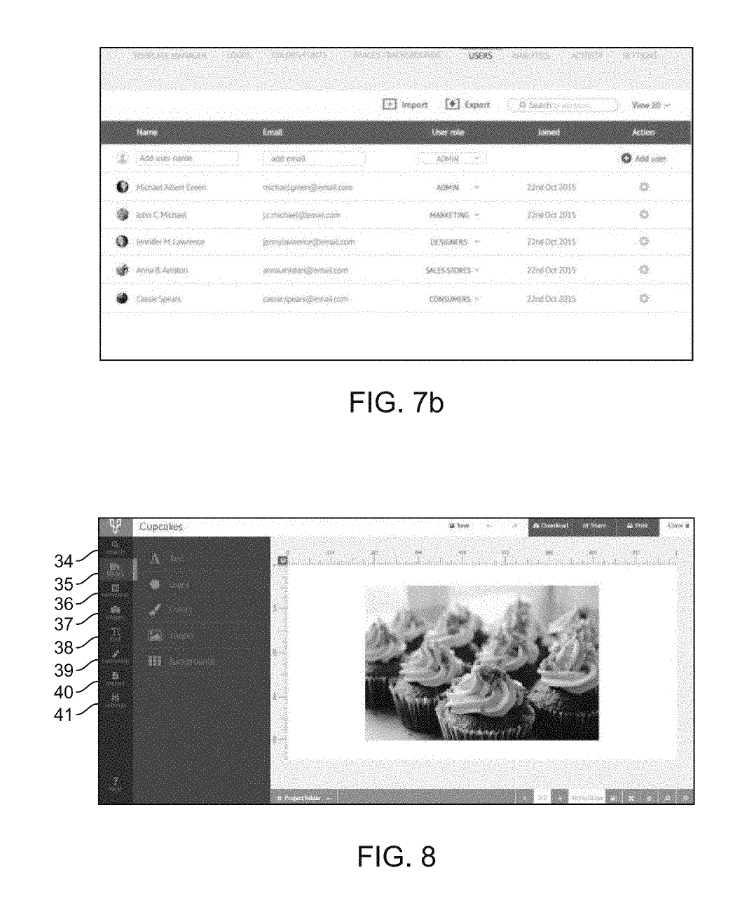

FIG. 7a is an exemplary embodiment representing user roles and usage rights. These roles are also used on the template creator to set design restrictions. There are many pre-defined roles (32) that are suggested to the business admins, and also these roles (32) can be changed, and more roles (32) can be added as required. The account permissions (33) given are, but not limited to: invite users, import users, change plan, make new templates, publish templates, delete templates, approve templates, notify about new templates, add assets images, delete asset images, share asset images, add formats, delete formats, add campaign, delete campaign. In this user interface authorized business users can access many different aspects of their account including the user roles manager interface under settings (31), the template manager (24), the business assets under logos (25), colors/fonts (26) and images/background (27), the users associated with the business (28), analytics (29), activity (30).

FIG. 7b disclose an exemplary list of users with their business roles. The user interface for business administrators to manage at least one another user associated with the business. It allows them to add, delete and change user roles depending upon the usage rights and/or restrictions, the business administrator imposes on the at least one another user.

Referring to FIG. 8, that discloses about the library access (35) of the system within the online editor (18) It allows for the users to quickly access their content uploaded in a database including logos, images, backgrounds, fonts, and colors. An image search module allows for image searches on the internet and within 100% royalty free websites (34). A quick resize allows users for any artwork to be quickly resized to different formats. The online editor allows for the same artwork to be edited from a computer or mobile device or from any communication device capable of transmitting radio frequency signals.

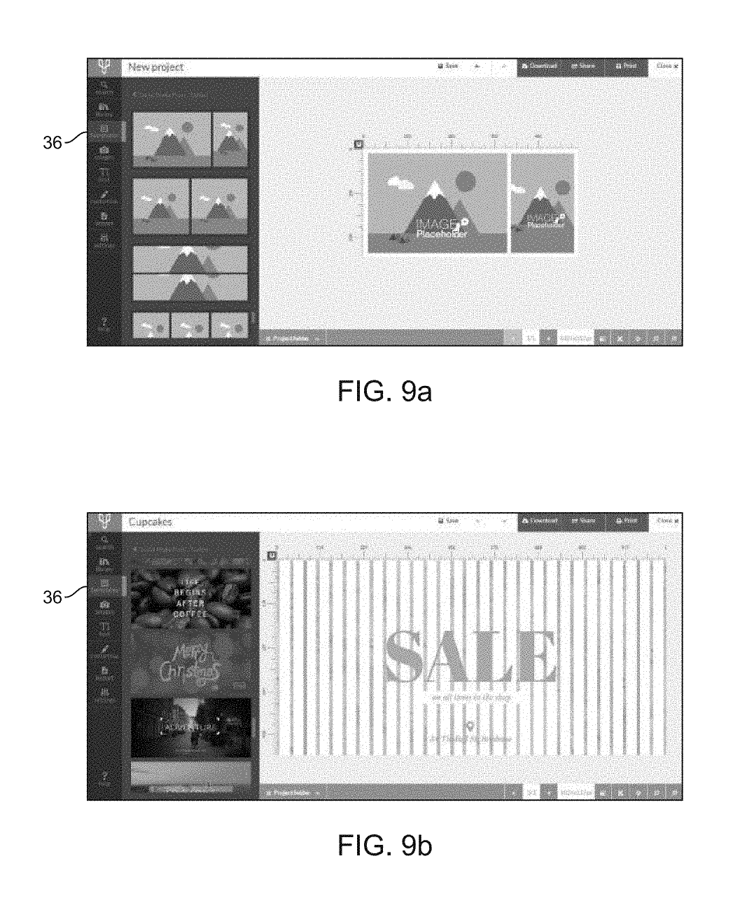

FIG. 9a disclose about various templates (36). A template (36) is a pre-designed artwork which facilitates the design process for users who do not have any design skills. An image frames tool allows for perfect image positioning within a delimited area, so that the user can replace an image without changing the look of the artwork.

FIG. 9b discloses another exemplary embodiment about various templates (36). The users can modify these pre-defined templates (36) by replacing/editing existing elements, adding new elements, or deleting elements.

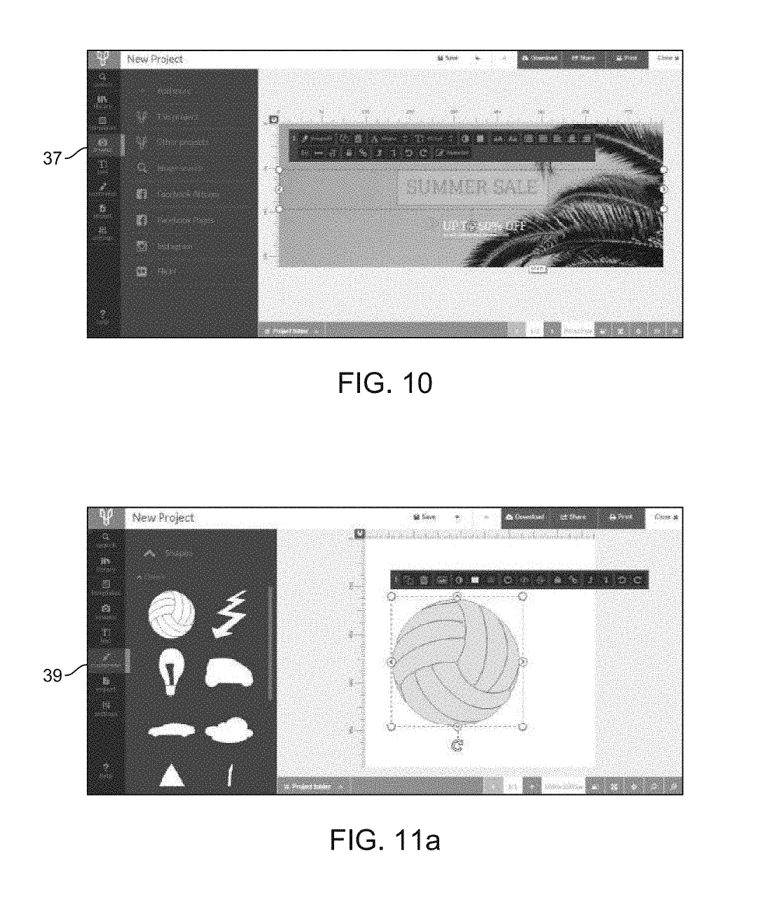

FIG. 10 is a tool that discloses about uploading/inserting various images (37). It allows for users to easy access of content using third party integrations included but not limited to Facebook, Instagram, Google+, Flickr, Google Drive, and Dropbox integration. A photo editor tool allows for image cropping, as well as for filters, color and saturation changes.

FIG. 10 displays also a text tool that discloses various functionalities for editing text. The text editor tool shown in user interface allows the users to resize, choose from a list of fonts, apply bold, underline, align, change color, and edit parts of a sentence. Text can be added using the text tab (38).

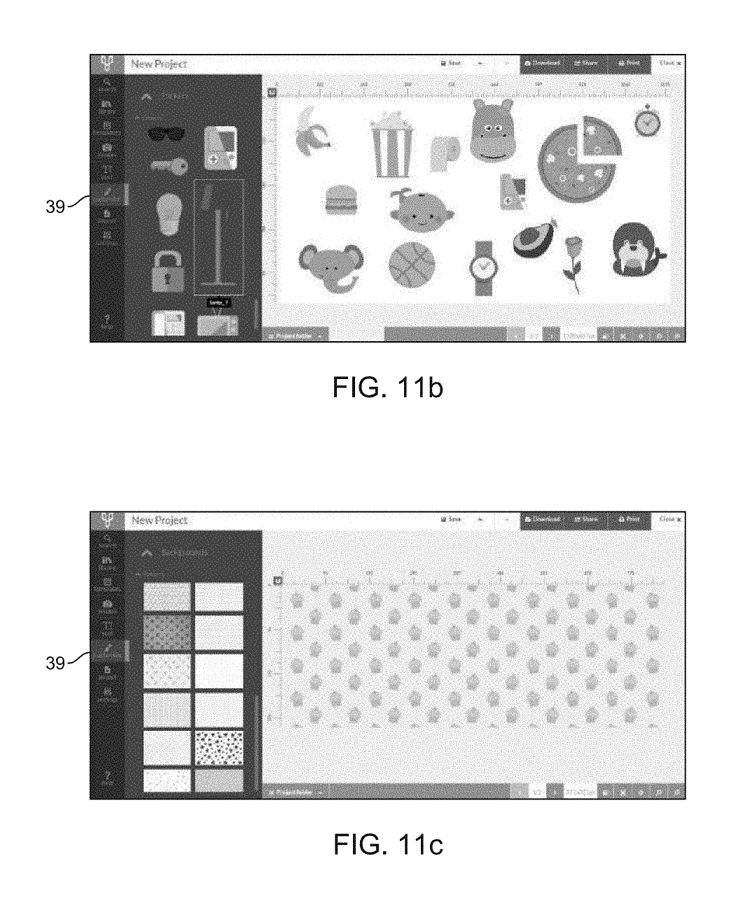

FIG. 11a represents a customization tool (39) for inserting and editing various shapes. A vector graphic editor allows for resizing, color and opacity changes, rotation, and element grouping.

FIG. 11b represents the customization tool (39) for inserting and editing vector art. A vector art allows collection of shapes and vectors and made available to users and the users can also upload their own shapes and images.

FIG. 11c represents the customization tool (39) for inserting and editing various backgrounds. The collection of backgrounds are made available to the users in accordance with their roles and usage rights, and the users are also authorized for uploading new background images of their own.

In one embodiment of this invention a layers manager tool allows users for level management within the artwork and for elements to be sent to the front or the back of the artwork. A project manager tool allows the users for multiple artworks to be combined and edited as part of the same project. They can be the pages of a documents, or artwork of different sizes. The users can delete, duplicate, and change the order that the artwork appears in the project.

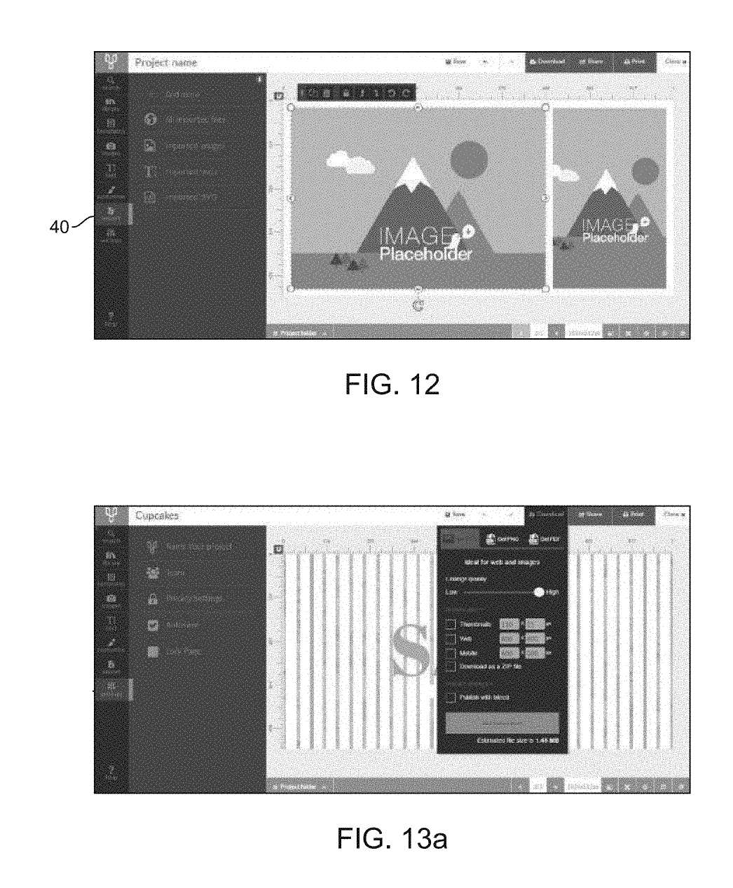

FIG. 12 discloses an import module for importing existing files (40). It allows for different artwork in the form of templates (36) to be imported from existing PSD and PDF files.

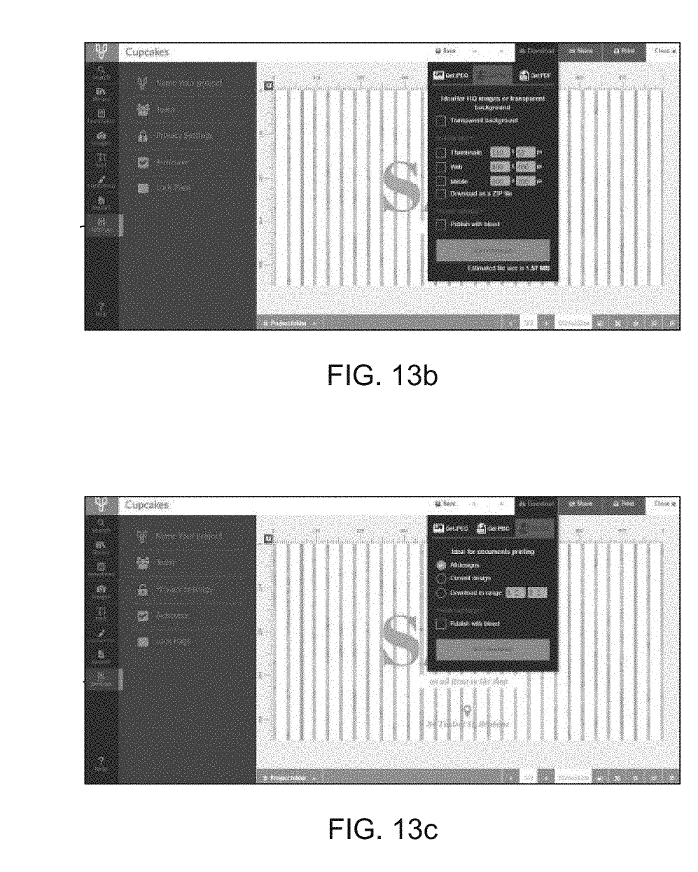

FIG. 13a discloses settings module and various options for jpeg file types. A renderer module allows the user to download the artwork created on the online editor in plurality of formats such as in jpeg as shown in the figure. A publisher module allows users to publish the designs straight on social media, or on online editor software itself, so others can view what was created. It also allows users to print their artwork.

FIG. 13b discloses settings module and various options for png file types. A renderer module allows the user to download the artwork created on the online editor in PNG format that includes transparent background option.

FIG. 13c discloses settings module and various options for pdf file types. A renderer module allows the user to download the artwork created on the online editor in PDF print ready file. The file formats may be chosen from the group of JPEG, JPG, TIF, GIF, PNG, html, mp3, WAV, AIFF, AU or raw mp4, avi, PDF but not limited to these only.

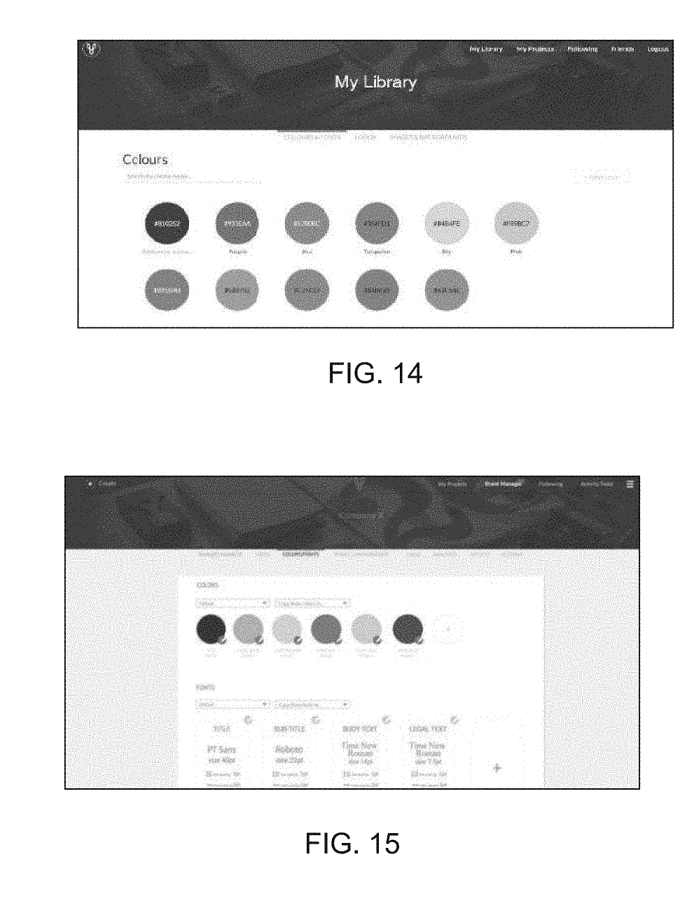

FIG. 14 discloses the user interface for the user library (21) and various colors and fonts. A library allows the users to select their default text, fonts, and colors, upload their own logos, images, and backgrounds.

In one embodiment of the invention a notification system and feed users are notified of any invites, new templates, and activities other users they choose to follow.

FIG. 15 discloses the user interface for users with assets permissions to manage the business assets, in this example titled company X, and set default text, upload and select fonts, colors, upload logos, images and backgrounds, and organize them into folders.

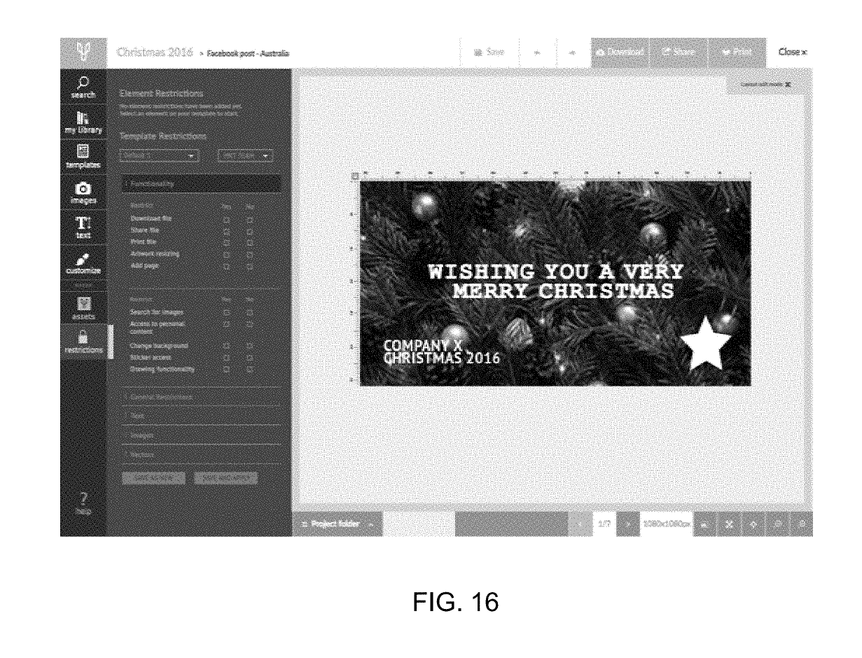

FIG. 16 discloses the restrictions that can be set within the template maker and linked to different user roles. The template maker is a version of the online editor that allows for authorized business users to work with the full functionality of the editor, have access to the company's assets and, set restrictions for different user roles. The restrictions may be template based or element based. The template based restrictions may limit functionality, for example cannot download file, or can only download with the approval of other users, or work as a default rule for all elements on that template, for example all text cannot be edited. The functionality restrictions may include, but are not limited, to download file, share file, print file, artwork resizing, add page, yes, or no, search for images, user's access to personal content, change background, add sticker and drawing functionality. Element based restrictions are applied to a selected element on canvas. An easy way to see what restrictions have been applied to each element of the template, is to activate the preview template restriction mode.

There are a plurality of general restrictions available for the users and these are discussed below but not limited to these only and these are size, opacity, color deletion, duplication, rotation and flipping, positioning on canvas, layer positioning, grouping and ungrouping.

In one embodiment of the invention the system for online editing to create artwork with layers embedded with a processing unit along with a storage module that is adapted to store a plurality of executable modules. A vector graphic editor module executed by the processing unit, adapted to provide at least one editing operation and a vector art module executed by the processing unit, adapted to provide a plurality of shapes and vectors to a user. A photo editor module executed by the processing unit, adapted to perform at least one editing operation on the selected shapes and an image frame module executed by the processing unit, adapted to provide image positioning of an image within a delimited area. A text editor module executed by the processing unit, adapted to perform at least one editing operation on an inserted text. A text banner module executed by the processing unit, adapted to frame text within the delimited area. A layer manager module executed by the processing unit, adapted to provide level management within the artwork; and a project manager module executed by the processing unit, adapted to edit and combine a plurality of the artwork.

In one embodiment of the invention a plurality of text restrictions may be such as size, opacity, color, deletion, duplication, rotation and flipping, content change, positioning on canvas, layer positioning, grouping & ungrouping, font size, font family, letter, line and word spacing, alignment, numeric content (for example price cannot be lower than $50), text content (for example, no profanities, valid website address valid email address), date format (for example it cannot be later than 25^{th} of December 2016).

In one of the embodiment of the invention the various usage rights and restrictions for images includes but not limited to size, opacity, color, deletion, duplication, rotation and flipping, positioning on canvas, layer positioning, grouping and ungrouping, filter, crop, replacement, content, where only images from a certain asset image folder can be used.

In one another embodiment of the invention the vectors have a plurality of set of restrictions depending on the user role and usage rights and these includes but not limited to size, opacity, color, deletion, duplication, rotation and flipping, positioning on canvas, layer positioning, grouping and ungrouping and stroke.

In one another embodiment of the invention the element restriction option will only show up when an element is selected on the canvas. The restriction options are pre-selected considering the template restrictions, but they can be edited. The restriction options for each element contain all the options listed for that element type on the template restriction.

In one another embodiment of the invention the authorized users are notified of new templates via email and also through the notification system. The authorized users access the templates via create screens. The authorized user selects what format he/she would like to create and the template options are shown on a screen for selection and they use the online editor to edit the templates.

In one another embodiment of the invention the editor accesses the restriction database to verify what the user can and cannot edit. The user will have access to the template restrictions preview, be prompted to replace text fields and images. The user will also be told what he or she can-not change.

In one another embodiment of the invention restricting the plurality of templates include a plurality of template restrictions, restricting how users edit templates to create their own artwork. The editing of the new artwork includes change of content of the new artwork by the at least one another user, wherein the editing of the selected areas is adaptively dependent on at least one usage right assigned to the at least one another user.

In one another embodiment of the invention the usage rights are assigned by the business admin to at least one another user depending upon their roles and responsibilities in the organizations. At least one another user can only edit a specific areas of the template to create their own artwork and cannot change each and every field unless authorized to do the same.

Although, throughout the description above, the preferred embodiment of the invention describes the utility of tool for the artwork, it is to be understood by those skilled in the art that the scope of the present application is not essentially limited to use of the tool for the artworks or visual elements, rather contents such as videos, web pages can also be managed using the proposed tool.

Even though we mentioned businesses the whole way through, this system could also be used by schools, ONGs, public figures and others who may find It useful. It will finally be understood that the disclosed embodiments are presently preferred examples of how to make and use the claimed invention, and are intended to be explanatory rather than limiting of the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology The scope of the invention supported by the above disclosure should accordingly be construed within the scope of what it teaches and suggests to those skilled in the art, and within the scope of any claims that the above disclosure supports. The scope of the invention is accordingly defined by the following claims.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A system for online editing to create artwork with layers, comprising:
a processing unit;
a storage module connected to said processing unit, wherein said storage module is adapted to store a plurality of executable modules, wherein a graphic editor module executed by said processing unit, adapted to provide at least one editing operation;
a vector art module executed by said processing unit, adapted to provide a plurality of shapes and vectors to a user;
a photo editor module executed by said processing unit, adapted to perform at least one editing operation;
an image frame module executed by said processing unit, adapted to provide image positioning of an image within a delimited area;
a text editor module executed by said processing unit, adapted to perform at least one editing operation on an inserted text;
a text banner module executed by said processing unit, adapted to frame text within said delimited area;
a layer manager module executed by said processing unit, adapted to provide level management within said artwork;
a project manager module executed by said processing unit, adapted to edit and combine a plurality of said artwork; and
a template maker module executed by said processing unit, adapted to allow for restrictions to be saved within the said artwork.

2. The system as claimed in claim 1, wherein said at least one editing operation is selected from the group of resizing, color, opacity, rotation, layer movement, element and combination thereof.

3. The system as claimed in claim 1, wherein said at least one editing operation is adapted to be executed by a communication device selected from the group of a cellular phone, laptop, computer, radio frequency communicating devices, PDA and combination thereof.

4. The system as claimed in claim 1, wherein said vector art module facilitates said user for uploading said plurality of shapes and vectors.

5. The system as claimed in claim 1, wherein said at least one editing operation is selected from the group of cropping, filtering, color saturation, and combination thereof.

6. The system as claimed in claim 1, wherein said image frame module is adapted to replace an image without changing appearance of said artwork.

7. The system as claimed in claim 1, wherein said text editor is adapted to insert text without changing the appearance of said artwork.

8. The system as claimed in claim 1, wherein said at least one editing operation is selected from resizing, font, bold, underline, alignment, text color, editing parts of a sentence and combination thereof.

9. The system as claimed in claim 1, wherein said layer manager is adapted to shift elements from front and back of said artwork.

10. The system as claimed in claim 1, wherein said storage module is adapted to store a plurality of content in a database.

11. The system as claimed in claim 10, wherein said plurality of content includes logos, images, background fonts, templates and color.

12. The system as claimed in claim 1, wherein said artwork is subjected to be downloaded by said user in a plurality of data formats by using a renderer module.

13. The system as claimed in claim 12, wherein said plurality of data formats is selected from the group of JPEG, JPG, TIF, GIF, PNG, html, mp3, WAV, AIFF, AU or raw mp4, avi, PDF and combination thereof.

14. The system as claimed in claim 1, wherein said artwork is adapted to be published, on the web, on social media networks and accessible by other users.

15. The system as claimed in claim 1, wherein said user receives a plurality of notifications and invites from other users for new templates.

16. The system as claimed in claim 1, wherein said user can save usability and element restrictions on the artwork, and save it as a template that can be used by other users.

17. A method of managing branded materials, comprising:
creating an account for at least one another user by a business admin;
providing at least one business role to at least one another user;
managing said at least one another user;
creating a plurality of templates with restrictions to at least one selected areas by said users with said business role;
managing said plurality of templates by a business representative;
analyzing a data related to a artwork created using said templates and/or campaigns; and
managing at least one activity permission.

18. The method as claimed in claim 17, wherein said business admin is provided to have an access to a business manager module.

19. The method as claimed in claim 17, wherein said at least one business role is adapted to provide a set of design restriction.

20. The method as claimed in claim 19, wherein said at least one business role are editable and/or changeable by said business admin.

21. The method as claimed in claim 19, wherein said design restrictions are selected from the group of an invite users, import users, change plan, make new templates, publish templates, delete templates, approve templates, notify about new templates, add assets images, delete asset images, share asset images, add formats, delete formats, add campaign, delete campaign and combination thereof.

22. The method as claimed in claim 17, wherein said managing of said at least one another user includes addition, deletion and changes in said at least one business role.

23. The method as claimed in claim 17, wherein said at least one business role is selected from the group of setting default text, upload fonts, colors, logos, images, background images and combination thereof.

24. The method as claimed in claim 17, wherein said plurality of templates are grouped into a formats and said formats are grouped into a plurality of campaigns.

25. The method as claimed in claim 24, wherein said plurality of campaigns are provided to said at least one another user depending upon said at least one business role.

26. The method as claimed in claim 17, wherein said at least one another user having a campaign management permission is authorized to create a new campaigns, formats and templates.

27. The method as claimed in claim 17, wherein said analyzing said data related to said templates and/or campaigns includes number of times said template and/or campaign edited, downloaded, shared on social media, number of users logged and business roles of said users.

28. The method as claimed in claim 17, wherein said managing of at least one activity permission includes rejection and/or approval of said artwork created using said templates and/or print authorization, share authorization.

29. The method as claimed in claim 17, wherein said restriction on said plurality of templates limit a plurality of functionalities related to said templates.

30. The method as claimed in claim 29, wherein said plurality of functionalities are selected from the group of not downloadable, not editable text, element based restriction, functionality, share, print, resizing, add page, search for images, access to personal content, background change, sticker, drawing functionality, general restrictions, size, opacity, color, deletion, duplication, rotation and flipping, positioning on canvas, layer position, grouping and ungrouping, text restriction and combination thereof.

31. The method as claimed in claim 30, wherein said element based restriction adaptively provides a plurality of restriction options for an element type upon editing said template to create a new artwork.

32. A method of using branded materials, comprising:
creating a new artwork by selecting at least one template from a plurality of templates; and
editing said selected template according to one or more restrictions associated with said template.

33. The method as claimed in claim 32, wherein said editing of said selected template to create new artwork includes change of content of said template by at least one another user.

34. The method as claimed in claim 32, wherein said editing is restricted to one or more selected areas of said new artwork, where said editing is adaptively dependent on at least one usage right assigned to said at least one another user.
